(19) United States
(12) Patent Application Publication
(10) Pub. No.: US 2004/0173216 A1
(43) Pub. Date: Sep. 9, 2004

(54) Face mask comprising health-promoting resin

(76) Inventor: Sung Yong Park, Daegu City (KR)

Correspondence Address: LADAS & PARRY, 224 SOUTH MICHIGAN AVENUE, SUITE 1200, CHICAGO, IL, 60604, US

(21) Appl. No.: 10/657,995

(22) Filed: Sep. 8, 2003

(30) Foreign Application Priority Data
Mar. 3, 2003 (KR) KR20-2003-0006151

(51) Int. Cl. A62B 18/08; A62B 23/02

(52) U.S. Cl. 128/206.12; 128/206.19

(57) ABSTRACT

Disclosed herein is a face mask comprising a health-promoting resin. The face mask comprises a fibrous pad covering wearer's nose and mouth, and a pair of loops attached to both sides of the fibrous pad so as to hang them on both ears, respectively, wherein the pad is composed of an inner layer, an outer layer combined with the inner layer and a health-promoting resin interposed between the inner and outer layers. The face mask can substantially prevent microorganisms from entering the wearer's body by antimicrobial processing, thereby improving the wearer's health and promoting blood circulation to activate various cellular functions and growth-promoting effects in the wearer's body by far-infrared rays and anions generated in an appropriate amount from the health-promoting resin.

### BACKGROUND OF THE INVENTION

1. Field of the Invention

The present invention relates to a face mask comprising a health-promoting resin, and more particularly to a face mask comprising a fibrous pad covering a wearer's nose and mouth, and a pair of loops attached to both sides of the fibrous pad so as to hang them on both ears, respectively, the pad being composed of an inner layer, an outer layer combined with the inner layer and a health-promoting resin such as a resin made of loess or anion-emitting materials (hereinafter, referred to as a ‘loess resin’ and an ‘anion-emitting resin’, respectively) interposed between the inner and outer layers. The health-promoting resin allows the face mask to exhibit effects, including far-infrared radiation, antibacterial activity, deodorant properties, and humidity and heat conservation, thereby improving the wearer's health.

2. Description of the Related Art

Generally, face masks are sanitary products which cover a wearer's nose and mouth to prevent airborne bacteria and dust from entering and scattering from the wearer's body. General face masks comprise a fibrous pad covering a wearer's nose and mouth, and a pair of loops attached to both sides of the fibrous pad so as to hang them on both ears, respectively.

Cold air directly inhaled by a wearer weakens the resistance to infection at the nasal and oral cavities of the wearer and thus the wearer is apt to catch a cold. The general face masks can prevent the wearer from catching a cold. However, airborne virus and bacteria can pass through the pad to enter and scatter from the wearer's body via the wearer's mouth and nose. Accordingly, such face masks cannot substantially protect the wearer's health.

In recent years, the sandy dust phenomenon has frequently occurred in Korea. Yellow dust contained in the sandy dust together with wind may pass through the pad of the general face masks, causing various diseases such as respiratory diseases and allergies. However, no special preventive measures against these diseases and allergies have been taken until now.

In order to solve these problems of the general face masks, Korean Utility Model No. 0292141 discloses a face mask for promoting health which comprises a body (pad) made of a cloth member and having a size sufficient to cover wearer's nose and mouth, and a pair of hangers (loops) attached to both sides of the body (pad), the body (pad) including an auxiliary cloth formed at a portion of the inner side of the body (pad) where the wearer's nose and mouth make contact, and a pair of blocking members symmetrically disposed between an inner cloth and an outer cloth of the auxiliary cloth, the pair of blocking members fill a space defined between the inner side of the body (pad) and left and right sides of the wearer's nose so that a passage in which the breath from the wearer's nose and mouth is concentrated is formed at a portion of the inner side of the body (pad) which corresponds to the position between the wearer's nose and mouth.

Since the blocking members covering the wearer's nose and mouth are formed at the inner side of the body (pad) so as to form a passage on which the breath from the wearer's nose and mouth is concentrated when the wearer inhales and exhales, the humidity and temperature in the passage are conserved by the moisture and heat generated upon exhaling. Accordingly, when ambient cold and dry air causing a cold passes through the passage upon inhaling, it is converted into warm and humid air. The face mask provides an advantage in that the attack and worsening of a cold can be prevented. However, the face mask cannot inhibit the fungal and bacterial propagation therein, causing respiratory diseases. Accordingly, the face mask cannot substantially protect the wearer's health. In addition, since the blocking members may cause the wearers inconvenience, it is not practical.

### SUMMARY OF THE INVENTION

Therefore, the present invention has been made in view of the above problems, and it is an object of the present invention to provide a face mask which can block ambient cold air from being introduced into a wearer's body and substantially prevent microorganisms from entering the wearer's body by antimicrobial processing, thereby improving the wearer's health and promoting blood circulation to activate various functions of the wearer's body by far-infrared rays and anions generated in an appropriate amount.

In order to accomplish the above object of the present invention, there is provided a face mask, comprising a pad covering the wearer's nose and mouth, and a pair of loops attached to both sides of the pad so as to hang them on both ears, respectively, the pad being composed of an inner layer, an outer layer combined with the inner layer and a health-promoting resin interposed between the inner and outer layers.

In accordance with the face mask comprising a pad covering the wearer's nose and mouth, and a pair of loops attached to both sides of the pad so as to hang them on both ears, respectively, wherein the pad is composed of an inner layer, an outer layer combined with the inner layer and a health-promoting resin interposed between the inner and outer layers, a loess resin or an anion-emitting resin may be used as the health-promoting resin. The use of the health-promoting resin in the face mask of the present invention inhibits bacterial propagation and prevents respiratory diseases resulting from the sandy dust phenomenon frequently occurring in the spring.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a partial perspective view showing a health mask according to one embodiment of the present invention;

FIG. 2 is a cross-sectional view showing a health mask according to one embodiment of the present invention;

FIG. 3 is a rear view showing a health mask according to another embodiment of the present invention;

FIG. 4 is a cross-sectional view showing a health mask according to another embodiment of the present invention; and

FIG. 5 is a diagram showing a state that a wearer uses a health mask according to the present invention.

### DESCRIPTION OF THE PREFERRED EMBODIES

Hereinafter, preferred embodiments of the present invention will be explained in more detail with reference to the accompanying drawings. However, the accompanying drawings are given for illustrating the preferred embodiments of the present invention and are not to be construed as limiting the scope of the invention.

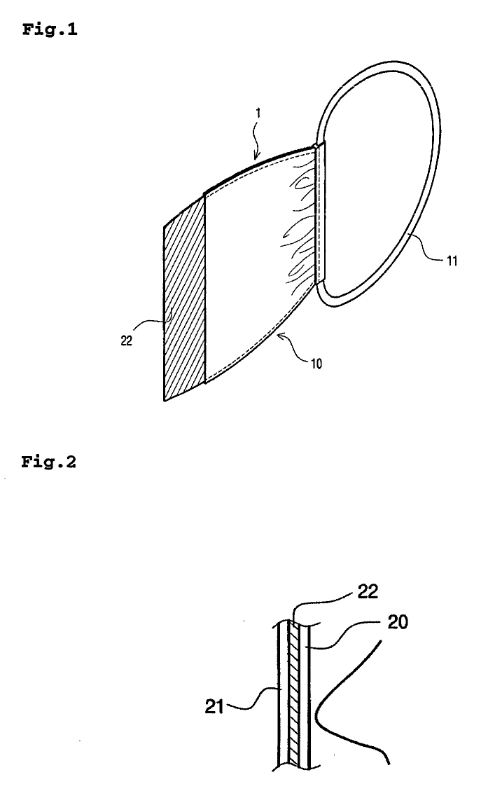

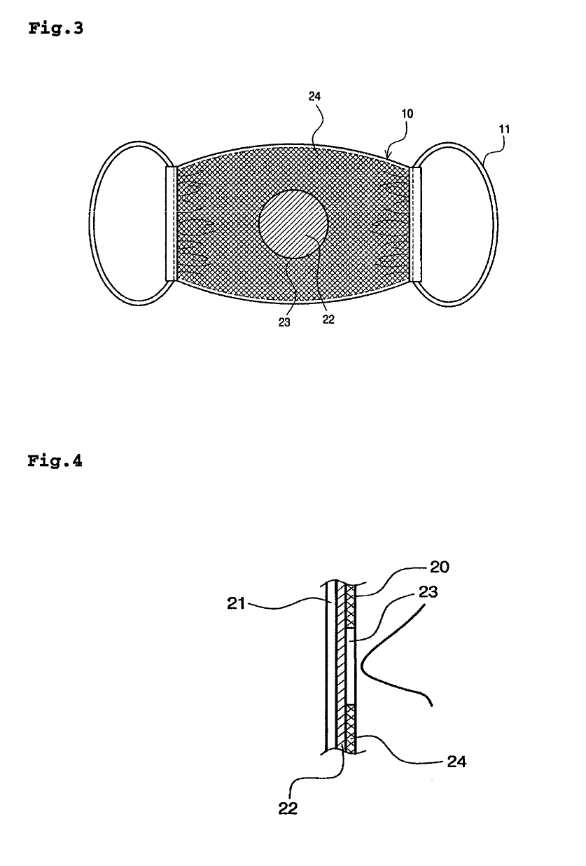

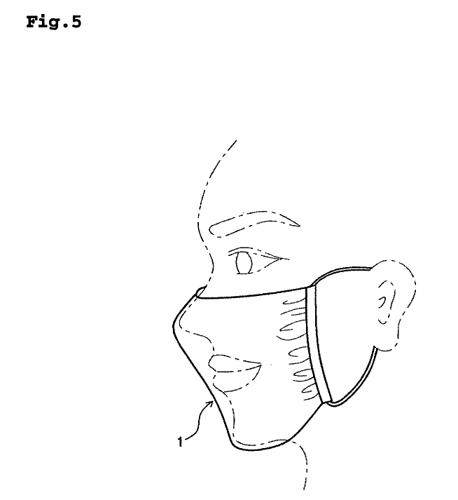

FIG. 1 is a partial perspective view showing a health mask comprising a health-promoting resin according to one embodiment of the present invention; FIG. 2 is a cross-sectional view showing a health mask comprising a health-promoting resin according to one embodiment of the present invention; FIG. 3 is a rear view showing a health mask comprising a health-promoting resin according to another embodiment of the present invention; FIG. 4 is a cross-sectional view showing a health mask comprising a health-promoting resin according to another embodiment of the present invention; and FIG. 5 is a diagram showing a state that a wearer uses a health mask comprising a health-promoting resin according to the present invention.

As shown in these figures, a face mask 1 of the present invention comprises a fibrous pad 10 covering the wearer's nose and mouth, and a pair of loops 11 attached to both sides of the fibrous pad 10 so as to hang them on both ears, respectively. The face mask 1 is a sanitary product for preventing airborne bacteria and foreign materials due to a cough and the sandy dust phenomenon from entering the wearer's body through the wearer's mouth and nose, and preventing direct contact with ambient cold and dry air. The pad 10 and the loops 11 are attached to form one integral structure.

The pad 10 allows the wearer of the face mask 1 to inhale and exhale through the wearer's nose and mouth when the wearer inhales or exhales atmosperic air, and has a size sufficient to cover the wearer's nose and mouth. The loops 11 are attached to both sides of the pad 10, respectively, for ease in wearing the face mask 1.

Referring to FIGS. 1 and 2, the pad 10 includes an inner layer 20 and an outer layer 21 combined with the inner layer 20, each of which is made of common fiber paper.

A space is defined between the inner layer 20 and the outer layer 21. A health-promoting resin 22 such as a loess resin or anion-emitting resin is inserted into the space in a manner such that the health-promoting resin 22 is directly brought into contact with the wearer's nose and mouth. According to this construction, although the wearer of the face mask 1 sensitively responds to the health-promoting resin 22, undesirable side effects is minimized.

The loess resin may be prepared by numerous methods, e.g., adsorbing a high quality loess to cotton or a cloth of a common fiber paper to coat it; mixing a loess with herbal materials including pine needles, mugwort, cnidium, cnidium, chitosan, germanium, etc., and adsorbing the mixture to a natural fiber, e.g., aspidium; and mixing a solution of the herbal materials, minerals, glutinous rice, etc., with an adhesive agent, immersing the mixture in a fiber containing cotton or yarn, and coating the surface of the immersed product using a brightener. The loess resin thus prepared shows excellent far-infrared radiation, antibacterial activity and fire-retardation.

The anion-emitting resin is a functional resin prepared by dispersing a natural mineral material in natural pure cotton, a non-woven fiber for mats or a special non-woven fibrous resin for bedclothes or clothes, and emits anions in an amount of about 700˜1000EA/CC, which is the most beneficial range to the human body. The anion-emitting resin uses a tourmaline-based ionizable material as the natural mineral so that all elements bear negative charges and generates an appropriate amount of anionic electrons from the negative charged elements. The anion-emitting resin makes the human body alkaline and promotes blood circulation, thereby activating cellular functions and metabolism of the body.

In addition to the loess resin and the anion-emitting resin, UV shielding materials, aromatic materials and far-infrared ray radiating materials can be used.

The UV shielding materials can block UV light harmful to the body to maintain the skin to be healthy and reflect visible light to keep inner atmosphere cool and fresh, thereby having excellent aeration and amenity. The aromatic materials are prepared by attaching fine aromatic-containing capsules to the surface of a fiber. The fine capsules are ruptured by friction to emit various kinds of aromatics. The far-infrared ray radiating materials are prepared by specially treating with phophyry or bioceramics, thereby promoting blood circulation and improving flexibility of the human body. Further, hard charcoal can be used as the health-promoting resin 22. The hard charcoal exhibits excellent efficacies in terms of anion emission, far-infrared radiation, electromagnetic wave shielding, mineral generation, deodorant property, dehumidifying property, autonomic balancing function, etc.

As shown in FIGS. 3 and 4, the health-promoting resin 22 selected from the loess resin and the anion-emitting resin is interposed between the inner and outer layers 20 and 21. The inner layer 20 has a through hole 23 formed at a predetermined position of the inner layer 20. The through hole 23 has a size sufficient to come into contact with the wearer's nose and mouth. The through hole 23 prevents bacterial propagation due to far-infrared rays radiated and anions emitted from the health-promoting resin 22, and promotes blood circulation.

In an alternate embodiment, while the health-promoting resin 22 is interposed between the inner and outer layers 20 and 21, a net 24 may cover the inner layer 20 so as to directly and indirectly accommodate far-infrared rays radiated and anions emitted from the health-promoting resin 22. In another preferred embodiment of the present invention, a portion other than the through hole 23 formed at a predetermined position of the inner layer 20 may be covered by the net 24.

Functions and effects of the face mask 1 according to the present invention will be explained in more detail below.

Since the face mask 1 comprising the pad 10 having a predetermined size and the pair of loops 11 attached to both sides of the pad 10 so as to hang them on both ears, respectively, the wearer can use the face mask 1 in order to cover parts of the wearer's face, e.g., nose and mouth, as best shown in FIG. 5, when the wearer catches a cold or during the sandy dust phenomenon occurring between March and May.

While the wearer wears the face mask 1 and inhales, the outer layer 21 of the pad 10 blocks atmospheric air from directly contacting with the wearer, and prevents airborne bacteria and fungi from entering the wearer's body. Accordingly, the face mask 1 of the present invention can inhibit cold symptoms from being worsened, and at the same time, prevent sandy dust from being inhaled. On the other hand, while the wearer wears the face mask 1 and exhales, the inner layer 20 can prevent respiration heat from being emitted to the outside, thereby improving humidity and heat conservation without damaging other persons.

In accordance with the face mask 1 of the present invention, the health-promoting resin 22 such as loess resin and anion-emitting resin interposed between the inner layer 20 and the outer layer 21 of the pad 10 can promote blood circulation in the wearer's body, prevent fungal propagation and help removal of malodor. At this time, since the inner layer 20 can keep the wearer's nose and mouth apart from the health-promoting resin 22 upon inhaling or exhaling, even wearers sensitively responding to the health-promoting resin 22 can use the face mask 1 of the present invention without any undesirable side effects.

The through hole 23 and the net 24 formed disposed at a predetermined portion of the inner layer 20 allow the health-promoting resin 22 to be contacted with desired portions of the wearer's face.

As apparent from the above description, according to the face mask of the present invention, the health-promoting resin such as loess resin and anion-emitting resin interposed between the inner layer and the outer layer of the pad can substantially prevent microorganisms from entering the wearer's body by antimicrobial processing, thereby improving the wearer's health and promoting blood circulation to activate various cellular functions and growth-promoting effects in the wearer's body by far-infrared rays and anions generated in an appropriate amount from the health-promoting resin.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A face mask which comprises a pad covering wearer's nose and mouth, and a pair of loops attached to both sides of the pad so as to hang them on both ears, respectively, the pad being composed of an inner layer, an outer layer combined with the inner layer and a health-promoting resin formed in a predetermined size and interposed between the inner and outer layers.

2. The face mask comprising a health-promoting resin according to claim 1, wherein the inner layer has a through hole formed at a predetermined position of the inner layer, and the through hole has a size sufficient to come into contact with wearer's nose and mouth.

3. The face mask comprising a health-promoting resin according to claim 1, wherein the inner layer of the pad is covered with a net.

4. The face mask comprising a health-promoting resin according to claim 1, wherein the health-promoting resin is a resin made of loess.

5. The face mask comprising a health-promoting resin according to claim 1, wherein the health-promoting resin is a resin made of anion-emitting materials.

6. The face mask comprising a health-promoting resin according to claim 1, wherein the health-promoting resin is a resin made of hard charcoal.
